(19) United States
(12) Patent Application Publication
(10) Pub. No.: US 2003/0172139 A1
(43) Pub. Date: Sep. 11, 2003

(54) System and method for delivering data in a network

(76) Inventors: Venkatachary Srinivasan, Sunnyvale, CA (US); Torsten Schulz, Pinneberg (DE)

Correspondence Address: Pennie & Edmonds, LLP, 3300 Hillview Avenue, Palo Alto, CA, 94304, US

(21) Appl. No.: 10/386,079

(22) Filed: Mar. 11, 2003

Related U.S. Application Data
(60) Provisional application No. 60/363,877, filed on Mar. 11, 2002.

(51) Int. Cl. G06F 15/16

(52) U.S. Cl. 709/221; 709/222; 709/248

(57) ABSTRACT

A system and method for standardizing data on a plurality of electronic devices. The system comprises: an intermediate server on which is stored a plurality of characterizations, wherein the plurality of characterizations includes a separate characterization for each of the plurality of electronic devices. The intermediate server comprises: a service provider that forwards a request from one of the plurality of electronic devices to one or more back-end software modules and for receiving data from the one or more back-end software modules; an auxiliary data management module that combines the data with an auxiliary data source in order to form a combined data feed; and a data transformation module for transforming the combined data feed in accordance with one of the characterizations. The method comprises storing a plurality of characterizations, detecting a change in data associated with one of the back-end software modules, receiving the change in data, in response to an interaction with one of the plurality of electronic devices, and creating an updated characterization for one of the plurality of electronic devices.

### RELATED APPLICATIONS

This application claims priority to, and incorporates herein by reference, an application entitled “SYSTEM AND METHOD FOR DELIVERING DATA IN A NETWORK,” filed on Mar. 11, 2002, and identified by serial No. 60/363,877 and attorney docket number 11114-005-888.

This application is related to, and incorporates herein by reference, an application entitled “SYSTEM AND METHOD FOR MANAGING TWO OR MORE ELECTRONIC DEVICES,” filed on Mar. 11, 2002, and identified by serial No. 60/363,802 and attorney docket number 11114-003-888; “SYSTEM AND METHOD FOR ADAPTING PREFERENCES BASED ON DEVICE LOCATION AND NETWORK TOPOLOGY,” filed on Mar. 11, 2002, and identified by serial No. 60/363,810 and attorney docket number 11114-004-888; and “SYSTEM FOR STANDARDIZING UPDATES OF DATA ON A PLURALITY OF HANDHELD DEVICES,” filed on Mar. 11, 2002, and identified by serial No. 60/363,876 and attorney docket number 11114-006-888.

### FIELD OF THE INVENTION

The present invention relates generally to the communication of data to devices and relates particularly to a method for ensuring that a number of different devices contain and access the same stored information as well as a system and method for enhancing back-end software services offered by a service provider.

### BACKGROUND OF THE INVENTION General State of the Art

The recent proliferation of electronic devices for recreation, information management and communication has taken routine computing power far away from the desk-bound personal computer. People in all walks of life are using such devices in the home, in the office, in factories, out in the field, and on the road. There is a diverse range of possible applications of such devices, including communication, business, navigation, entertainment, and even the management of basic household chores. The innovation rate continues to accelerate at a rapid pace—driven by end-user demand and the proliferation of new devices, standards, and protocols. Whereas today many users only access a single device for a single task, in the foreseeable future, users will want multiple functionality across many devices in their possession.

Although devices in use and those that can be envisaged come in all shapes and sizes, they present similar challenges for the people who make them and for the providers who offer services for them. This is because there are many attributes the devices share. Inside a typical device can be found hardware, and, interfacing with the user, the devices utilize various software components and often a complex operating system. Accordingly, there is potential for a single comprehensive infrastructure to be developed to enable a plethora of such devices to be upgraded, configured, and managed in a standardized manner. With standardization comes a greater desirability, reliability, and interoperability to meet the ever-increasing demands of end users.

Although cell phones, personal digital assistants, game stations, and car navigation systems are being used by a steadily increasing population of users, the level of user sophistication is not increasing significantly. Customers prefer to avail themselves of the advanced features of these devices without wanting the effort of configuring each new device for themselves. The user community is evolving into one that wants to take an idea, such as a list of frequently-dialed numbers, from one device to another but does not want to be distracted by the operating details of every device, nor the logistical complication of ensuring maximum consistency in their own data on all the available devices.

Furthermore, devices now becoming available are rarely single-function devices. Increasing the number of functions of a device only increases the level of personalization that is possible. Correspondingly, users are coming to expect unified access to their own data wherever they are—independent of what device they are using or what service they are connected to. Ideally, access to data should not depend on a user's location, as determined by which network a user has “roamed” into.

Accordingly, common problems associated with a world populated with a multitude of individual devices include: updating functionality on devices after sale, and preserving user-specific settings when coping with changes of location or device. These problems are preferably addressed by the companies that provide services and those that supply the devices rather than by the individual users. End users merely want devices that are easy to use, reliable, and enhanceable in a straightforward way.

Traditional service providers as well as large organizations such as airlines, banks, and a vast number of other enterprises, offer services to their customers and end users through devices. They want to increase their revenue from both existing and new services. They need to adopt ever more flexible ways of retaining existing customers and attracting new ones while continuing to add more services.

Device manufacturers want to upgrade existing devices with new software components more efficiently, and replace existing devices with new devices in such a way that time is not lost in transferring over a user's settings. The simpler it becomes for end users to upgrade and extend their usage, the more likely it is that those end users will buy new devices more frequently. Device manufacturers are also vying to sell additional devices to their installed customer base, for example a complex cell phone for business use and a simpler one for personal use. Along with service providers, device manufacturers want the flexibility to add new services, even to existing devices.

Thus, to successfully deploy, service, and maintain a plethora of devices, service providers and device manufacturers must be able to update them and add functionality to them after they have been sold. Such a capability not only preserves data, thereby enhancing its value to the user, but may also extend a device's useful lifetime. But such a task is complex not just because of the number of different types of devices currently available but because of the burgeoning number of individual users. Although a pair of devices may be identical, no two users are alike. So, vendors must get not just data to and from the device, but they must ensure user-specific or location-specific preferences are updated or maintained from one device to another, including when devices are replaced or upgraded. In short, vendors need flexible software component management, robust data management, and effective preference/configuration management.

Ultimately, then, end users want more device choices, more freedom to control preferences, more access to their data, and more personalization. At the same time, end users also want less hassle, less time spent reconfiguring preferences, and fewer worries about access to personal preferences while roaming and upgrading. Service providers want to be able to obtain more revenue from existing and new services, greater levels of customer retention, and more ways to improve the customer relationship. To achieve this, service providers want to minimize the overheads and time associated with deploying device upgrades, and want to spend less time on activities that are beyond their area of expertise. Device manufacturers want to be able to easily upgrade existing devices, sell more devices, and offer more services to gain a competitive advantage. Such gains will serve to optimize the product-development cycle time.

### End User Expectations

Specific problems associated with personal devices such as cell phones are that end-users do not want to be troubled with the need to reset preferences every time they roam into a different network. Similarly, when upgrading an existing phone or purchasing a second phone, the user does not want to reset their preferences from scratch and reenter a phone book. Such personal trends run up against the technological trend that cell phones, for example, are getting more powerful with an increasing number of features that require either the end user or a service provider to configure.

With a large number of options such as SMS, MMS, wireless internet (WAP), fast internet access, “Bluetooth” connectivity, SyncML, transparent access to data such as email, contacts, and calendar—even delivered through a corporate firewall, personalized ring tones and melodies, greater freedom to roam, and many others, cell phones are far from being fixed-function devices. Service providers and device manufacturers have to provide the appropriate device and preference functionality because users continue to demand more of their mobile devices.

Furthermore, the next generation of cell phones will be enhanced with PalmOS, Symbian, J2ME, WindowsCE, and other similar advanced operating systems to let service providers and end users download new software modules on their own. Similarly, personal digital assistants (PDA's) will have “Bluetooth”, infrared, wireless Ethernet (802.11a, 802.11b or 802.11g), or other connections to communicate with other electronic devices and to enable wireless access to the Internet and other networks from the PDA. Users will expect automatic configuration, so they simply achieve seamless access when they connect. Accordingly, software component management, data management, and preference/configuration management will become vital to make this efficient.

Correspondingly, the next generation of screen phones—whether based on traditional analog/digital circuit switched technology, or VoIP packet-switch technology—will offer an enhanced set of services that offer much more than a phone call. It is anticipated that end users will have access to voice and video conferencing while checking e-mail, contacts, calendar, stock quotes, news, and weather. Clearly, when presented with so many options, swift and easy upgrade of data and preferences will be desirable, if not essential.

Entertainment devices provide another arena in which standardization of upgrades and user preferences is likely to become important. Users of game consoles want to connect with a community of players so that they can compete, post scores, get hints and tips while playing, read game reviews, and generally share their experiences with other players around the world. Constant upgrades to game software and devices will be needed to satisfy these end users. But they will not be satisfied if they have to perform the upgrades themselves.

Similarly, televisions, set-top devices, personal video recorders, digital audio players such as MP3 players, and home audio systems have become devices with greatly enhanced functionality—including the ability to communicate with one another. The home entertainment center will soon comprise a number of separate but connected devices, enabling a variety of digital media to be shared throughout the house and among friends. The number of device upgrades required to achieve such a level of connectivity is likely to be more than any end user will be willing to make.

Many devices currently available can be referred to as “productivity devices.” For example, car navigation systems are already in widespread use. Car command centers can soon expect to be able to alert drivers to real-time traffic and construction delays. Plus, the ability to access e-mail, calendar, and address book from an in-car device will assist in improving productivity even when on the move. Even so, such facilities will benefit from transparent synchronized updates of individual users' preferences and data.

Internet terminals and “web pads” will, before long, offer very easy ways to perform standard functions such as internet browsing, e-mail transmission, calendar, as well as provide basic document creation tools such as word processors and spreadsheets. These systems and other systems with similar capabilities will serve as enhancements or extensions to PC's, without actually replacing PC's but will benefit enormously from synchronized update of preferences.

Daily life is also becoming more and more influenced by a category of devices known as “controller devices,” for example, cable routers, high-end appliances such as refrigerators, and alarm systems. Such devices typically take two forms: they are either the unseen black boxes that control certain critical daily functions; or they are the part of larger appliances that give the user functionality control. In both cases, these devices are converging towards other electronic devices in their capabilities, are becoming connected to the rest of the digital world and are communicating with other like devices. This convergence presents a challenge to service providers and device manufacturers not only because of the software management required, but also because these controllers have very long life cycles. With these long life cycles comes the need to enhance the controller devices while they are in use.

Today, these devices are hardware-intensive products that supply a single function. But as with personal devices, they are becoming more service-driven. Telemetry is one technology that allows the shift from product/device to product/service. Telemetry is a growing trend across a variety of devices that enables vendors to determine and analyze problems on working devices, fix the problems, and make adjustments to prevent the problems from recurring. As these devices get more user-specific and in need of constant upgrades, their complexity increases and the likelihood that they will benefit from a means for simplifying the upgrade process also increases. Telemetry is already being seen in cars, airplanes, and elevators today. Its application is likely to spread to phones, alarm systems, and “white goods” appliances.

In essence, people are wanting increasing levels of control, preferably from anywhere, on any device. Whether it is to control what their children can and cannot access on the internet and view on television or whether they want to control when their heater turns on and off, such levels of control require complex software component management, data management, and preference/configuration management.

Many household appliances, such as refrigerators, dishwashers, ovens, and washing machines, have not required network connections or software modules hitherto. In the future, the refrigerator, for instance, will be smart enough to monitor its own contents. But, in general, people simply want to buy a refrigerator that will be reliable and will last. Vendors, then, must somehow retain a customer relationship throughout a long product life cycle, so customers will want to purchase add-on services and retain brand loyalty. Using telemetry, service providers or device manufacturers can monitor devices such as a refrigerator, send data to their servers, analyze the data, modify the software, and prevent future problems. In a similar way, the car controller system monitoring the engine, fuel pump, etc., is not only interacting through the dashboard with the driver, but also can communicate with a service technician in real time.

This approach is far more cost-effective than sending a service technician out to the home each month to do the monitoring. In order for this monitoring to be carried out centrally and to be able to provide more comprehensive usage information, it would be useful to be able to update the state of the device easily. Such a capability would also benefit end users, who can have the same information at their disposal.

Communication controllers such as routers are specific devices for which end users and service providers both want more functionality, including features such as firewall, virtual private network, parental controls, anti-virus protection, and other services. The devices have got to run all the time, be secure, and enable access from any where, on any device. End users prefer the simplest interface possible, for example, selecting an internet service provider or paying a monthly fee, without worrying about its maintenance. That leaves the regular upgrading of the firewall, virtual private network, parental controls, and anti-virus protection to the service provider. The service provider would also like to monitor the device itself. For all of these tasks, the preference/configuration management and data delivery management demands are immense.

Phone system users in the home and in business want features such as conferencing, unified messaging, voice mail, routing, and forwarding without wanting to spend inordinate amounts of time setting preferences. They also want personalized features such as ring tones, melodies, and a specified number of rings before the phone switches to voice mail. And they expect their preferences to remain the same whether they upgrade or replace a device, or want to tie-in with their other devices. Organizations want to audit phone usage in order to negotiate better rates. Service providers and device manufacturers want to offer these services while monitoring reliability and usage. Basically, this is complex and difficult to manage with existing technologies.

The home or residential gateway is the single point where users connect all their communication systems, entertainment systems, alarm systems, heating and ventilation systems, and Instabus/X10 electrical systems. New standards for monitoring, controlling, and unifying these gateways are arising so users can turn on the house lights as they pull into the driveway, adjust the heat using their cell phone so it is ideal when they arrive, and check the status of all their systems while they are on vacation. The proliferation of new devices is nearly matched by the number of new protocols—resulting in a preference/configuration challenge for service providers and device manufacturers.

There has been a proliferation of wireless standards from 802.11a, 802.11b, and 802.11g to “Bluetooth” and HomeRF protocols. With multiple access points throughout the home or office, users add not only PC's but also PDA's, Web pads, and entertainment devices after the fact. Aside from the obvious compatibility problems, there is the matter of security: no one wants their neighbor or competitor using their wireless access points. Since end users do not want to manage and upgrade the device themselves, the responsibility falls to the service providers or device manufacturers to handle these complex demands.

Instabus or X10 systems must communicate with sensors and switches and aggregate a variety of devices. And a single alarm system must work with multiple monitoring devices—motion sensors, door and window sensors, glass-breaking sensors—and be accessed and operated from any where. The need for software component management, data management, and preference/configuration management is substantial.

In most large organizations, certain devices have to be up and running continuously. Planned downtime must be kept to a bare minimum. Unplanned downtime has severe negative consequences. This presents an enormous challenge to organizations because these devices are often in distant locations. Such devices must be centrally administered and managed—and the ability to update to new models while existing devices continue to be deployed is vital. These tend to be single-model devices, which means that any change affects a great number of devices. Thus, the organization's economic efficiency depends upon the way it manages these devices. Such devices are often referred to as “Vertical Solution” devices.

Organizations, service providers, and device manufacturers have been creating vertical solution devices such as banking terminals, cash registers, and industrial controllers for years. But the above challenges have forced them to commit precious time and resources to building homegrown solutions for device, preferences, and data management, which is not their core area of expertise.

From self-service terminals and dialog terminals to machine controllers, industry-specific devices are deployed by organizations and operated by customers or employees who may not be technically savvy. Ease of use and reliability are critical, because these devices are essential to the well-being of the organization. They play a key role in customer satisfaction, product and service delivery time, and overall productivity.

Banking terminals are examples of self-service terminals that originally provided customers the ability to deposit and withdraw money. As with all other computing devices, the functionality and features of these terminals continue to grow. Each branch wants to offer its own promotions and serve customers in a more personalized fashion. Location-based services—even non-banking services—greatly enhance the customer experience while directly benefitting the organization. Branches can target promotions depending on a customer's net worth. Or, they can base offers on whatever the interest rate happens to be on that given day. This requires continuous two-way communication with headquarters, so corporate data must be accessed and sent immediately. And if the terminal is not operating, it has a significant effect on customer satisfaction, which directly affects customer loyalty.

Check-in terminals are fast becoming a familiar sight in airports, rental car agencies, and at events such as movies and concerts. They need to be simple, because the end user does not want to read complicated instructions just to get tickets. They must also be reliable, because their purpose is to decrease the time spent in line and enhance customer satisfaction. The devices' feature sets must be able to change seamlessly and be easily customized so that airlines, for instance, can target promotions toward frequent fliers or alter promotions quickly as demands change.

Large chain stores and restaurants—and even some individually owned establishments—feature rather sophisticated cash registers, as well as other examples of “dialog terminals.” These devices are constantly altered to account for new products, prices, and customer-loyalty promotions. They also must accommodate ever-changing connectivity with bar-code and credit-card readers. And they must also be easily self-serviced by employees who have not been trained with the requisite computing skills.

Mobile data units are used by delivery companies such as Federal Express and United Parcel Service, transportation providers, rental car companies, and field-service personnel to improve customer satisfaction and productivity through two-way connectivity to headquarters. On the road, on the train, in the hospital, or at the construction site, these devices help keep people connected. This requires flexible connectivity—for example, Bluetooth on the road and Wi-Fi (e.g., 802.11b) at the home base. It is desirable for these devices to be seamlessly upgraded in real time, thereby extending the product life cycle.

Finally, industrial machines such as printing presses and assembly lines are reconfigured for the job at hand, whether that is a new print run or a new automobile model. As critical as these machines are to an organization's earnings, the operators tend to know their machines, not the computing backbone necessary to run them. This can be problematic since these machines can be among an organization's biggest investments—and if they stop working, the organization stops earning money. Ultimately it would be desirable to have access to a software infrastructure that allows the organizations or device manufacturers to build solutions that provide the ability to modify settings in real time and add new feature sets to improve productivity automatically.

Given the above background, what is needed in the art are solutions that provide service providers with easy and reliable methods to improve, customize, and distinguish their services relative to competing service providers.

### SUMMARY OF THE INVENTION

The present invention provides systems and methods that enable a service provider to enhance the services and content provided by a user. One advantage of the present invention is that a service provider may enhance back-end software applications such as stock tracking programs, address programs and accounting programs even in instances where the service provider does not have access to the software code for the back-end software applications. Another advantage of the present invention is that users may register all their devices with an intermediate server. Once the devices are registered, user preferences are synchronized across the devices. Furthermore, the service capabilities of each device are used in a coordinated fashion to deliver back-end data, such as E-mail, to any of the devices. Furthermore, the coordinated use of the service capabilities of each registered device works without any requirement that any of the devices is reliably connected to the intermediate server.

One aspect of the present invention provides a method for standardizing data on a plurality of electronic devices. A service provider offers one or more back-end software modules to at least one of the plurality of electronic devices. Further, one of the back-end software modules has associated data. In the method, a plurality of characterizations is stored. The plurality of characterizations includes a separate characterization for each of the electronic devices. A change in the data associated with one of the back-end software modules is detected. In response to an interaction from one of the plurality of electronic devices, the change in the data associated with one of the back-end software modules is received. Finally, an updated characterization for the electronic device is created. In some embodiments, each separate characterization includes a description of a software module in the corresponding electronic device. In another embodiment, each separate characterization includes a description of a hardware component included in the corresponding electronic device. In still another embodiment, each separate characterization includes a description of an electronic device setting in the corresponding electronic device. In another embodiment, each separate characterization includes a characterization of user-defined preferences of the corresponding electronic device. In another embodiment, each separate characterization comprises control information for data maintained on the corresponding electronic device. In still another embodiment, the separate characterization includes a description of data maintained on the corresponding electronic device. In some embodiments of the present invention, the electronic device in the plurality of electronic devices is a pager, a car navigation system, a router, a switch, a handheld computing device, a wireless telephone or a home gateway appliance.

Another aspect of the present invention provides a method for delivering data to an end-user in a networked environment. In the method, data requested from the end-user is received in a centralized location. The data is transformed to form transformed data in accordance with a plurality of characterizations. The plurality of characterizations includes a separate characterization for each of a plurality of electronic devices associated with the end-user. Then, for each electronic device in the plurality of electronic devices, the transformed data is stored in the centralized location. In some embodiments, the step of receiving data requested from the end-user further comprises detecting a change in data associated with a back-end software module. When such a detection arises, the back-end software module is queried for the change in the data and the data that has been changed is obtained from the back-end software module. In some embodiments, the method further comprises opening a connection between the centralized location and one of the plurality of electronic devices associated with the end-user. This connection is used to transfer the data that has been transformed to the electronic device. In some embodiments, the transformed data is processed by the electronic device. In some embodiments of the present invention, the plurality of electronic devices includes a pager, a car navigation system, a router, a switch, a handheld computing device, a wireless telephone, or a home gateway appliance.

Another aspect of the present invention provides a method for providing data in a networked environment. The method includes the step of retrieving referenced data from a back-end software module. The referenced data is combined with an auxiliary data source in order to form a combined data feed. The combined data feed is transformed in accordance with a characterization of a device. The characterization of the device is from a plurality of characterizations. The plurality of characterizations includes a separate characterization for each of a plurality of electronic devices. In some embodiments, the method further comprises communicating said combined data feed to said device. In some embodiment of the present invention, the auxiliary data source is relational database, a lightweight directory access protocol (LDAP) data store, or a file store. In some embodiments back-end software module is an LDAP data store, an Internet Message Access Protocol mail store, a Microsoft Exchange server, or a relational database containing service provider data. In some embodiments of the present invention, an electronic device in the plurality of electronic devices is a pager, a car navigation system, a router, a switch, a handheld computing device, a wireless telephone or a home gateway appliance.

Another embodiment of the present invention includes an apparatus for providing data in a networked environment. The apparatus comprises a plurality of electronic devices for originating a request. Further, the apparatus includes an intermediate server that is intermittently connected to at least one device in the plurality of devices. The intermediate server includes a plurality of characterizations, the plurality of characterizations including a separate characterization for each of the plurality of electronic devices. Further, the intermediate server includes a service provider communication module for forwarding the request to a back-end software module and for receiving data from the back-end software module in accordance with the request. The intermediate server also includes an auxiliary data management module for combining the data with an auxiliary data source in order to form a combined data feed. Further, the intermediate server includes a data transformation module for transforming the combined data feed into a transformed data feed in accordance with a characterization selected from the plurality of characterizations. In some embodiments, the intermediate server further comprises a device communication module for receiving the request and for communicating the transformed data feed to the device that corresponds with the characterization selected from the plurality of characterizations. In some embodiments of the present invention, the back-end software module is hosted by a back-end server that is in communication with the intermediate server. In some embodiments of the present invention the back-end software module is a stock tracking program, an address program, an E-mail program, or an accounting program. In still other embodiments of the present invention, an electronic device in the plurality of electronic devices is a pager, a car navigation system, a router, a switch, a handheld computing device, a wireless telephone or a home gateway appliance.

### BRIEF DESCRIPTION OF THE DRAWINGS

Additional objects and features of the invention will be more readily apparent from the following detailed description and appended claims when taken in conjunction with the drawings, in which:

FIG. 1 illustrates a system that supports surrogate data delivery in accordance with one embodiment of the present invention.

FIG. 2 illustrates exemplary processing steps for delivering data using a surrogate data delivery mechanism in accordance with one embodiment of the present invention.

FIG. 3 illustrates a system that supports “side-car” data delivery in accordance with one embodiment of the present invention.

FIG. 4 illustrates exemplary processing steps for delivering “side-car” data in accordance with one embodiment of the present invention.

FIG. 5 illustrates an electronic device in accordance with one embodiment of the present invention.

FIG. 6 discloses an architecture of the intermediate server 60 in accordance with one embodiment of the present invention.

Like reference numerals refer to the same element throughout the several views of the drawings.

### DESCRIPTION OF THE PREFERRED EMBODIMENTS

### Data Delivery Apparatus

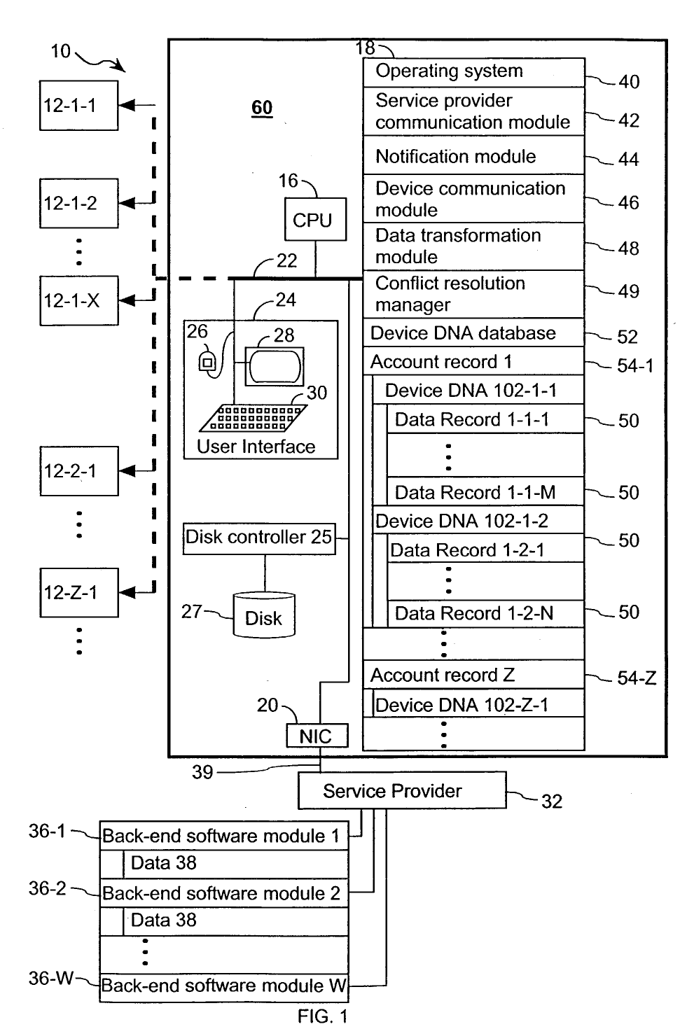

FIG. 1 illustrates a system 10 that is operated in accordance with one embodiment of the invention. System 10 includes one or more electronic devices 12, an intermediate server 60, a service provider 32, and one or more back-end software modules 36. Each device 12 is an electronic device that is capable of communicating with intermediate server 60. Service provider 32 is an electronic service such as an internet service provider. As illustrated in FIG. 1, each of the electronic devices 12 are connected to intermediate server 60. Such a connection may be through a network 2 (not shown). The connection of devices 12 to intermediate server 60 (optionally, through network 2 [not shown]) is typically a wireline connection (e.g., a connection comprising metallic wire conductors and/or optical fibers). The electronic devices 12 are not typified by any particular type of connection. The electronic devices can be connected to intermediate server 60 by a wireline connection and/or a wireless connection (e.g., a connection comprising electromagnetic waves such as RF, infrared, laser, visible light, and acoustic energy). More information about exemplary electronic devices is found below in the section entitled “Exemplary electronic devices.”

Representative service providers 32 include those described in conjunction with FIG. 1, above. Back-end software modules 36 are software applications that are offered as services to users of device 12. Exemplary back-end software modules 36 include software application such as stock tracking programs, address programs, E-mail programs, and accounting programs. Available back-end software modules include, but are not limited to applications such as Microsoft Exchange Server (Redmond, Wash.) and Lightweight Directory Access Protocol (LDAP) servers. LDAP is designed to run directly over a TCP/IP stack. (See http://www.kingsmountain.com/ldapRoadmap.shtml). Another example of an available back-end software module is an Internet Message Access Protocol (IMAP) server. An IMAP server provides a method of accessing electronic mail or bulletin board messages that are kept on a (possibly shared) mail server (see http://www.imap.org). Yet another example of available back-end software modules 36 include Yahoo! Addressbook, Calendar, etc. (Sunnyvale, Calif.). An additional exemplary back-end software module is an Oracle Database (Redwood City, Calif.).

Although the network topology shown in FIG. 1 illustrates a service provider 32 that is external to intermediate server 60, the invention is not limited to such a topology. In fact, in some embodiments of the present invention, server provider 32 is a software module that is hosted by intermediate server 60. Furthermore, in some embodiments of the present invention, back-end software modules 36 are hosted by intermediate server 60. Each back-end software module 36 may have one or more associated data structures 38 for storage of data such as addresses, stock quotes, accounting information, or user preferences.

In embodiments in which service provider 32 is not hosted by intermediate server 60, the service provider 32 host (not shown) and intermediate server 60 are connected by a communications network 39. Communications network 39 is a local area network (LAN), wide area network (WAN), metropolitan area network (MAN), an Intranet, the Internet, or any combination of such networks.

Communication of data between computers within a network and between computers in different networks is handled by a hierarchy of protocols each of which simplifies a stage in the communication process (see for example, Computer Networks, A Systems Approach, Peterson, L. L. and Davie, B. S., Morgan Kaufmann, Inc., 1996, incorporated herein by reference).

Intermediate server 60 includes standard server components including a central processing unit 16, high speed random access memory 18 for storing program modules and data structures, a network interface 20 for coupling intermediate server 60 to other computers via communication network 39, a disk controller 25 for controlling non-volatile storage 27, and one or more busses 22 that interconnect these components. Communication network 39 optionally includes one or more routers.

Optionally, intermediate server 60 includes user input/output device 24. User input/output device 24 includes one or more user input/output components such as a mouse 26, display 28, and keyboard 30.

Random access memory 18 includes a number of modules and data structures that are used in accordance with the present invention. However, it will be appreciated that a portion of any of the modules and/or data structures stored in random access memory 18 may, in fact, be stored in non-volatile form on non-volatile storage 27. In a typical embodiment, memory 18 includes an operating system 40. Operating system 40 includes procedures for handling various basic system services and for performing hardware dependent tasks. In one embodiment, operating system 40 includes procedures for handling various basic system services and for performing hardware dependent tasks.

Memory 18 includes service provider communication module 42. Service provider communication module 42 communicates with service provider 32. The protocol that service provider communication module 42 uses to communicate with service provider 32 will depend on the exact specifications of service provider 32.

Memory 18 optionally includes notification module 44. Notification module 44 is used to track whether there is a change in the state of data 38. When such a change occurs, notification module 44 informs service provider communication module 42. The action taken by module 42 when such a notification occurs is application specific, and will be discussed in more detail below.

Memory 18 further includes device communication module 46. Module 46 communicates with devices 12. Module 46 works in conjunction with device DNA database 52 in order to accomplish this task. DNA database 52 includes a device DNA record 102 for each device 12 in system 10. The term “device DNA” is used to provide a descriptive term for record 102. However, the term characterization is equally applicable. Thus, the terms “device DNA” and “characterization” are interchangeable in the instant application. Each device DNA record 102 is characterized by an account 54. Each account 54 corresponds to a separate end-user of system 10 and includes all devices 12 registered to the end-user. There is a one-to-one correspondence between each device 12 in system 10 and a corresponding device DNA 102 record. In one embodiment, each device 12 is uniquely represented by a separate device DNA record 102 in DNA database 52. In such embodiments, each device DNA record 102 tracks information about the corresponding device 12. This device information preferably includes, but is not limited to, hardware characteristics of the device, such as display capabilities, memory capabilities, user preferences, a description of software applications that are loaded on the device, and a characterization of the data that is present on the device. Further details of device DNA can be found in U.S. provisional patent application attorney docket number 11114-003-888, entitled “SYSTEM AND METHOD FOR MANAGING A PLURALITY OF ELECTRONIC DEVICES”, filed on even date herewith and which is incorporated herein by reference in its entirety. An embodiment of the present invention that details how device DNA database 52 is populated is described in the section entitled “Exemplary DNA database” below.

Memory 18 further includes data transformation module 48. Data transformation module 48 is used to convert data received from service provider 32, such as portions of data 38, into a form of data that can be delivered to the targeted device 12. Data transformation module 48 in conjunction with device DNA 102 provides a number of advantages to system 10 that are not found in known systems. First, system 10 can be used in network topologies in which a user has registered one or more devices 12 with intermediate server 60. A device 12 is registered with intermediate server 60 when intermediate server 60 has a device DNA 102 that represents the device. An example where a single user has multiple devices 12 registered with intermediate server 60 is found in FIG. 1. In FIG. 1, devices 12-1-1, 12-1-2, . . . , 12-1-X, belong to user 1, devices 12-2-1, 12-2-2, etc. belong to user 2, and so forth. Thus, in network topologies in which a user has registered one or more devices 12, data transformation module 48 can customize data that is intended for a particular user. In particular, transformation module 48 can customize the data to each of the devices registered by that user, using the device DNA 102 of each device. Another advantage of system 10 is that there is no requirement for a device 12 to be connected to intermediate server 60. Device communication module 46 tracks whether or not a device 12 is in communication with intermediate server 60. When a connection is formed, device communication module 46 maximizes the productivity of the connection using the transformed data 50 that has been stored for the device by data transformation module 48.

Finally, memory 18 includes a conflict resolution manager 49. Conflict resolution manager 49 is used to resolve conflicts in data associated with a given user. Conflicts arise when multiple updates to the same data item occur at various places. For example, consider the case where a device 12 is a PDA such as a “Palm Pilot” and back-end software module 36 is a Microsoft Exchange Server (See http://www.microsoft.com/exchange/default.asp). On the Palm you might change the private phone number of your colleague, while on the Exchange Server, the entry for the colleague gets a new office phone number by the administrator of the Exchange server. When synchronizing, there will be a conflict because the same address book entry was edited at different locations. Advantageously, conflict resolution module 49 determines that, although both addresses were changed, the conflict could be resolved because the changes affect different fields (private phone, office phone). In addition, when a conflict differs from the previous example in the sense that the conflict cannot be resolved automatically, conflict detection module 49 prompts the user to decide which entry is valid. Because of the advantageous architecture of system 10, this conflict resolution request can be stored by data transformation module as the separate data 50 associated with each device associated with the user. Thus, the configuration request prompt (i.g. a customized interactive query that is provided to the end-user in order to solicit a reply to a question) that is stored in the data 50 associated with the user's cell phone will have a different format from the same configuration request prompt that is stored in the data 50 associated with the user's PDA. Furthermore, device communication module 46 will erase redundant prompts from data records 50 when the user answers the configuration prompt using any registered device 10. To illustrate, conflict resolution manager 49 determines that there is a conflict in the data associated with the user that cannot be automatically resolved. Conflict resolution manager 49 sends a conflict request to data transformation module 48. Data transformation module 48 stores a conflict request formatted to the specifications of the user's PDA in a data record 50 that is associated with the user's PDA. Transformation module stores a second conflict request formatted to the specification of the user's cell phone in a data record 50 that is associated with the user's cell phone, e.g., data record 2. When the user calls in to the server 60 using the cell phone and answers the configuration prompt, device communication module 46 erases the configuration request from the data record associated with the user's palm.

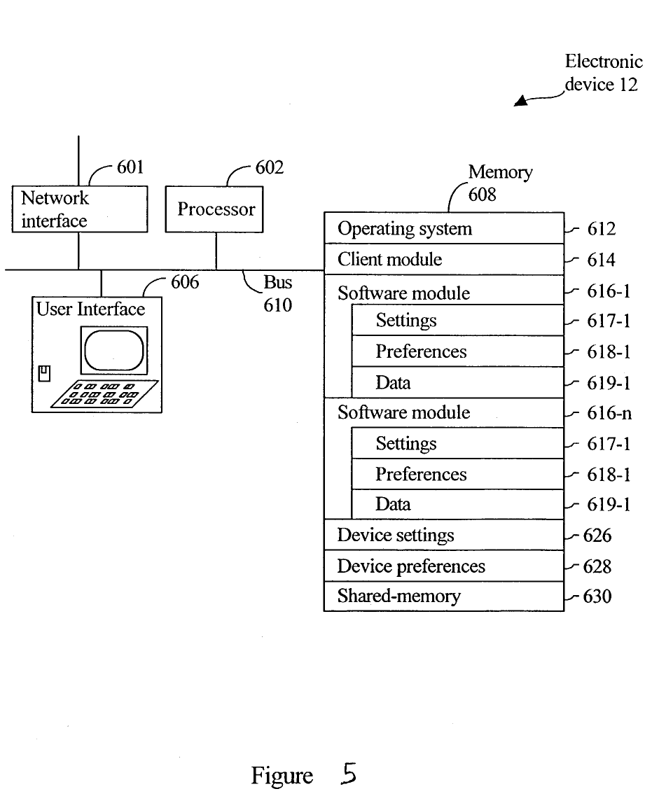

In one embodiment of the present invention, conflict resolution manager 49 is designed to detect conflicts between software modules that are, or may be, installed on an electronic device 12. More specifically, the conflict module 49 defines software modules needed to provide a particular service subscribed to by a user and available through a corresponding electronic device 12 and defines dependencies and conflicts between services, between services and components, and between services and hardware components (e.g., the size of memory 208 [FIG. 5]). Using this information, in conjunction with device DNA 102, the conflict module 49 determines whether a software module to be installed on an electronic device 12 will operate successfully. If not, the conflict module 49 modifies the device DNA 102 such that this software module is not installed until the conflict module 49 determines that the software module will operate successfully. A change in such a determination usually results from software and/or hardware changes on the corresponding electronic device 12 (e.g., a conflicting software module is removed and/or memory 208 [FIG. 5] is expanded).

In one embodiment of the present invention, service provider 32 creates an account for each user (e.g., corporate entity or individual) who uses the services provided by the service provider 32. The account typically specifies information such as usernames and passwords, authorized users, service level, and services subscribed to (i.e., a given account may provide access to only a subset of the services provided by a given service provider 32). An account preferably specifies one or more electronic devices 12 used in conjunction with the account. For example, a given account may indicate that a PDA and a cell phone (two types of electronic devices 12) may be used to access services provided by service provider 32 (through intermediate server 60). The account preferably includes, therefore, information that can be used to identify and/or contact an electronic device 12 (e.g., a telephone number of a cell phone) corresponding to the account. Additionally, service provider 32 preferably provides a means for modifying the account. In some embodiments, a web-based interface is provided to permit a user to add, remove, or modify one or more services (back-end software module 36) and electronic devices 12 corresponding to the account. More specifically, in some embodiments, an electronic device 12 is configured to access only a subset of services (back-end software module 36) otherwise available to or through a corresponding account. This account information is passed on to intermediate server 60, which incorporates this information into the device DNA database 52 (FIG. 1).

An electronic device 12 typically includes the following components: a network interface, a processor, a user interface, a memory, and a bus, which interconnects the aforementioned components. The network interface couples the electronic device 12 to the intermediate server 60. The precise structure of this component is governed by how the electronic device communicates with the intermediate server 60 (e.g., wireless or wireline). The processor executes various software modules maintained in the device 12 memory. The user interface enables a user to interact with the electronic device 12 and typically includes components such as a keyboard, touch pad screen/display, microphone, and speakers.

### Exemplary Data Delivery Processing Steps

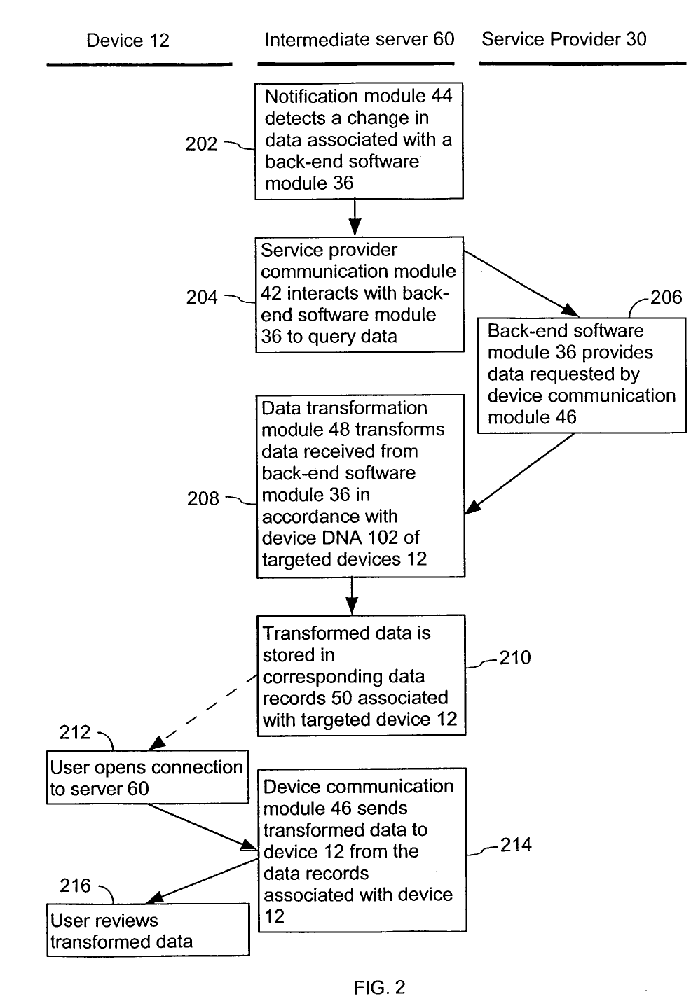

Now that the representative architecture of a data delivery system 10 in accordance with one embodiment of the present invention has been disclosed, processing steps in accordance with system 10 will be disclosed using FIG. 2 as a reference. The exemplary processing steps shown in FIG. 2 illustrate the advantages of optional notification module 44. Module 44 is used to detect a change in the state of the data 38 associated with a back-end software module 36. There are many different mechanisms for detecting such changes. For instance, a notification from the back-end system could be realized with a trigger in an SQL database system. Accordingly, in step 202, notification module 44 detects a change in data associated with back-end software module 36. A backend software module 36 that is an E-mail program serves to illustrate this processing step. A change in the state of data 38 in this case would arise when the E-mail program receives an Email message intended for the user. Another example is a back-end software module 36 that is a voice-mail server. A change in the state of data 38 in this instance would be the receipt of a voice-mail intended for the user by module 36 and the storage of the voice-mail in data 38. Yet another example is the case in which back-end software module is a stock tracking service. When an alert, triggered by a predefined change in a stock or commodity price arises, the state of data 38 will change. Alternatively, the module 36 will communicate directly to notification module 44. When a change in the state of data 38 occurs or back-end module 36 directly notifies notification module, server 60 will trigger service provider communication module 42 to interact with back-end software module 36 to query data 36 and/or to respond to a notification provided by module 36 (FIG. 2, step 204).

In processing step 206, back-end software module 36 provides data requested by device communication module 46. It will be appreciated by those of skill in the art that there are alternative methods for performing steps 204 and 206. Indeed, a notification from back-end software module 36 to notification module 44 and/or service provider communication module 42 may include all the necessary data. Therefore, in such instances, processing steps 204 and 206 are merged into a single step. In processing step 208, data transformation module 48 transforms data received from back-end software module 36 in accordance with device DNA 102 of the devices associated with the targeted user. This transformed data is then stored in the data records 50 that are associated with the devices of the targeted user (step 210).

To understand the advantages of step 208, consider the case in which the data requested by device communication module 46 in step 206 is an E-mail message that has two attachments, a sound attachment and an image attachment. In this scenario, the user has registered four devices with intermediate server 60. The first device has an E-mail program that supports image and sound files. In this case, data transformation module 48 reviews the device DNA 102 associated with the first device and stores the E-mail, complete with attachments, in a data record 50 that is associated with the first device. The second device that the targeted user has registered with server 60 has an E-mail program that supports image but not sound files. In this case, data transformation module 49 reviews the device DNA 102 associated with the second device, discovers that the E-mail program does not support sound, and stores the E-mail message, without the sound attachment, in a data record 50 that is associated with the second device. The third device that the targeted user has registered with server 60 has an E-mail program that does not support image or sound. In this case, the Email message is stored without attachments in a data record 50 associated with the third device. The fourth device that the user has registered with server 60 does not include E-mail capabilities. Data transformation module 48 ascertains this from the device DNA 102 associated with the fourth device. In this instance, data transformation module may convert the E-mail to voice-mail or some other capability that the fourth device has, such as paging or some form of text messaging capability and store the converted E-mail in a data record 50 that is associated with the fourth device.

One of skill in the art will appreciate the many advantages that data transformation module 48 provides. For example, module 48 may be used to intelligently edit E-mail messages for devices that have limited E-mail capability. In another example, transformation module 48 may be used to provide a user with the best possible services on any given device 12 that is used by a user to connect to server 60.

At some point, a user opens a connection to server 60 using a registered device 12, as shown in FIG. 2, step 212. When this occurs, device communication module 46 checks to determine whether there is any outstanding data, requests for data, or user prompts that need to be communicated to device 12. Typically this is done by reviewing the data records 50 that are associated with the device 12. In one example, the data records 50 that are associated with the device may include a conflict resolution request, an E-mail message and/or a user preferences update. A user preferences update will be stored in the data record 50 associated with the device 12 when the user has updated preferences in another device that the same user has registered with intermediate server 60. In this example, device communication module sends the conflict resolution request, the E-mail message and/or the user preference update to the device 12 (step 214). In step 216, relevant transformed data is reviewed by the user with the device 12. For example, in the example provided above, the Email message and the conflict resolution request are made available to the user. However, the user preference update is typically not displayed to the user. In some embodiments, the user is presented with an alert that system preferences are about to be changed. Further, the user is given the option to cancel this request.

The processing steps disclosed in FIG. 2 provide just one case scenario in which system 10 (FIG. 1) is used. Many other scenarios are possible and indeed likely to arise using system 10. In one embodiment, intermediate server 60 serves as a data delivery mechanism system and/or a front end to a service provider 32. In such embodiments, intermediate server 60, and in particular the modules 42, 44, 46, and/or 49 as well as data structures 50 and/or 102 enhance the capabilities of service provider 32 with minimal program coding requirements.

### Exemplary Side-Car Data Source Apparatus

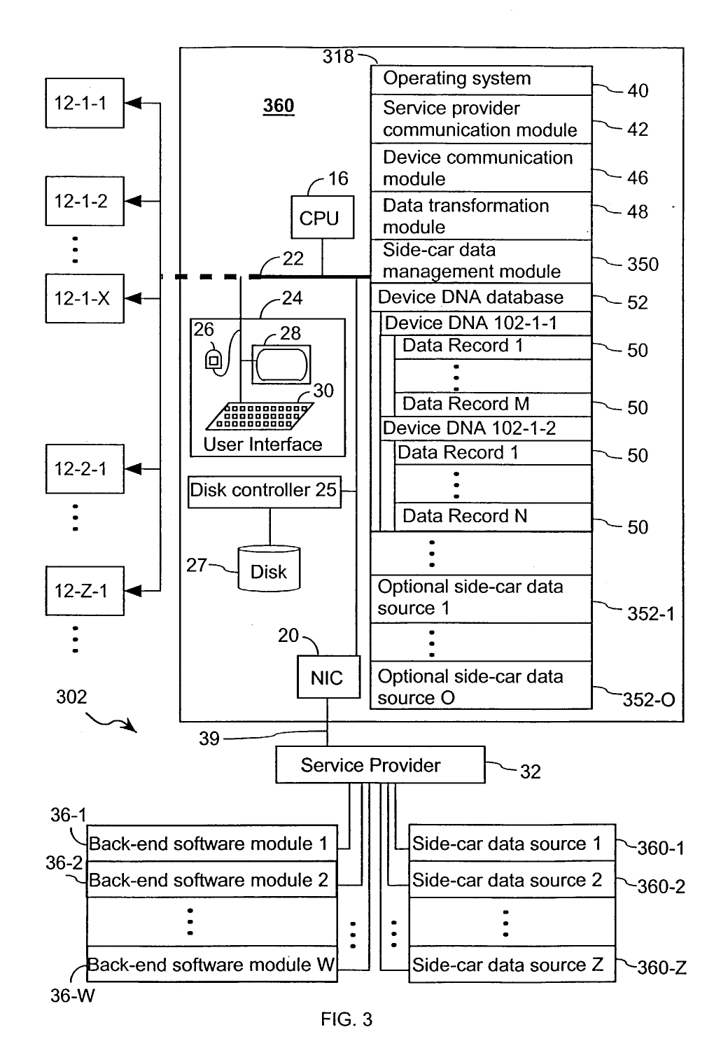

FIG. 3 illustrates a system 302 that is capable of allowing a service provider 32 to enhances the capabilities of back-end software module 36. System 302 includes one or more electronic devices 12, an intermediate server 360, a service provider 32, and one or more back-end software modules 36. Each device 12 is an electronic device that is capable of communicating with intermediate server 360. Service provider 32 is an electronic service such as an Internet service provider. As illustrated in FIG. 3, each of the electronic devices 12 are connected to intermediate server 360. Such a connection may be through a network 2 (not shown). The connection of devices 12 to intermediate server 360 (optionally, through network 2 [not shown]) is typically a wireline connection (i.e., a connection comprising metallic wire conductors and/or optical fibers). The electronic devices 12 are not typified by any particular type of connection. The electronic devices can be connected to intermediate server 360 by a wireline connection and/or a wireless connection (i.e., a connection comprising electromagnetic waves such as RF, infrared, laser, visible light, and acoustic energy). More information about exemplary electronic devices 12 is found below in the section entitled “Exemplary electronic devices.”

Representative service providers 32 include, but are not limited to, Deutsche Telekom (Bonn Germany), Yahoo! (Sunnyvale, Calif.), AT&T Broadband (Denver, Colo.), Microsoft Corporation (Redmond, Wash.), Sprint (Kansas City, Mo.), FedEx Corporation (Memphis, Tenn.), and OnStar (http://www.onstar.com/flash.html). Back-end software modules 36 are software applications that are offered as services to users of device 12. Exemplary back-end software modules 36 include software application such as stock tracking programs, address programs, E-mail programs, and accounting programs. Available back-end software modules include, but are not limited to applications such as Microsoft Exchange Server (Redmond, Wash.) and Lightweight Directory Access Protocol (LDAP) servers.

Although the network topology shown in FIG. 3 illustrates a service provider 32 that is external to intermediate server 360, the invention is not limited to such a topology. In fact, in some embodiments of the present invention, server provider 32 is a software module that is hosted by intermediate server 360. Furthermore, in some embodiments of the present invention, back-end software modules 36 are hosted by intermediate server 360. Each back-end software module 36 may have one or more associated data structures 38 (not shown) for storage of data such as addresses, stock quotes, accounting information, or user preferences.

In embodiments in which service provider 32 is not hosted by intermediate server 360, the service provider 32 host (not shown) and intermediate server 360 are connected by a communications network 39. Communications network 39 is a local area network (LAN), wide area network (WAN), metropolitan area network (MAN), an Intranet, the Internet, or any combination of such networks.

Intermediate server 360 includes standard server components including a central processing unit 16, high speed random access memory 318 for storing program modules and data structures, a network interface 20 for coupling intermediate server 360 to other computers via communication network 39, a disk controller 25 for controlling nonvolatile storage 27, and one or more busses 22 that interconnect these components. Communication network 39 optionally includes one or more routers (not shown).

Optionally, intermediate server 360 includes user input/output device 24. User input/output device 24 includes one or more user input/output components such as a mouse 26, display 28, and keyboard 30.

Random access memory 318 includes a number of modules and data structures that are used in accordance with the present invention. However, it will be appreciated that a portion of any of the modules and/or data structures stored in random access memory 318 may, in fact, be stored in non-volatile form on non-volatile storage 27. In a typical embodiment, memory 318 includes an operating system 40. Operating system 40 includes procedures for handling various basic system services and for performing hardware dependent tasks. In one embodiment, operating system 40 includes procedures for handling various basic system services and for performing hardware dependent tasks.

Memory 318 includes service provider communication module 42. Service provider communication module 42 communicates with service provider 32. The protocol that service provider communication module 42 uses to communicate with service provider 32 will depend on the exact specifications of service provider 32.

Memory 318 further includes device communication module 46. Module 46 communicates with devices 12. Module 46 works in conjunction with device DNA database 52 in order to accomplish this task. DNA database 52 includes a device DNA record 102 for each device 12 in system 10. Each device DNA record 102 is characterized by an account 54 (not shown). Each account 54 corresponds to a separate end-user of system 10 and includes all devices 12 registered to the end-user. There is a one-to-one correspondence between each device 12 in system 10 and a corresponding device DNA 102 record. This one-to-one correspondence is illustrated in FIG. 5. In one embodiment, each device 12 is uniquely represented by a separate device DNA record 102 in DNA database 52. In such embodiments, each device DNA record 102 tracks information about the corresponding device 12. This device information preferably includes, but is not limited to, hardware characteristics of the device, such as display capabilities, memory capabilities, user preferences, a description of software applications that are loaded on the device, and a characterization of the data that is present on the device. Further details of device DNA can be found in U.S. provisional patent application (docket no.) 01111-003-888 and entitled “SYSTEM AND METHOD FOR MANAGING A PLURALITY OF ELECTRONIC DEVICES.” An embodiment of the present invention that details how device DNA database 52 is populated is described in the section entitled “Exemplary DNA database” below.

Memory 318 further includes data transformation module 48. Data transformation module 48 is used to convert data received from service provider 32, such as portions of data 38 (not shown), into a form of data that can be delivered to targeted device 12. Data transformation module 48, in conjunction with device DNA 102, provides a number of advantages to system 302 that are not found in known systems. First, system 302 can be used in network topologies in which a user has registered one or more devices 12 with intermediate server 360. A device 12 is registered with intermediate server 360 when intermediate server 360 has a device DNA 102 that represents the device. Transformation module 48 can customize the data to each of the devices registered by that user, using the device DNA 102 of each device. Another advantage of system 302 is that there is no requirement for a device 12 to be connected to intermediate server 360. Device communication module 46 tracks whether or not a device 12 is in communication with intermediate server 360. When a connection is formed, device communication module 46 maximizes the productivity of the connection using the transformed data 50 that has been stored for the device 12 by data transformation module 48.

Memory 318 further includes side-car management module 350. Side-car data management module 350 enhances the capabilities of a service provider 32. Side-car data management module 350 works in conjunction with service provider communication module 42 and device communication module 46 to enhance the capabilities of back-end software modules 36. There are many different ways in which side-car management module 350 can perform this task.

In one embodiment, side-car management module 350 provides an additional feature to an existing back-end software module 36. For example, consider the case of a back-end software module that is an address program. The service provider offers the address program as a feature to track end-users to the service provider. However, because the address program is a commercial product, there is nothing that distinguishes the address program offered by the service provider 32 over the address program that is offered by other service providers 32. Advantageously, the service provider 32 can use side-car management module 350 to customize the features of the back-end address program. For example, if the address program does not allow the user to associate images with each address, side-car management module 350 can be used to add this capability to the address program without modifying the address program source code. Side-car data management module 350 performs the task of associating new data fields with an existing back-end software module 36 by referencing the data that is stored by the back-end software module. Thus, in the case of the exemplary address program, when a new address is stored by the address program, the record is referenced by side-car data management module 350. Side-car data management module 350 uses this reference to track when the address record is accessed by an end-user. Each time the address is referenced, the side-car management program adds the image that is associated with the record. In one embodiment of the present invention, the image that is associated with the referenced address record is stored as a data record 50 that is associated with each device that the end-user has that is capable of viewing the image.

More generally, in some embodiments of the present invention, the device DNA database 52 is divided into user accounts 54 (see FIG. 1). Each account 54 includes the devices 12 that are associated with the user. For each device, there is a corresponding device DNA 102. Furthermore, for each device 12 that is associated with the account 54, there exists corresponding data records 50. This data architecture is used to store the information required to support the additional features that module 350 creates in order to enhance backend software module 36. Thus, in the example above where the address program is customized to accept images, the images are indexed to a referenced address that is stored by the back-end address program and then stored in data records 50 that correspond to each registered device in an account that is provided by an end-user. In some embodiments, rather than storing a copy of the image in a separate data record 50 that is associated with each device in a user account, the image may be stored in a centralized database and each data record 50 in the user account is updated to include a pointer to the referenced image.

While FIG. 3 indicates that data records 50 are an integral part of device DNA database 52, the present invention imposes no limitations on the location of data records 50. Accordingly, data records 50 may be stored in a database that is external to device DNA database. The only requirement on the location and form of data records 50 is that they be accessible by intermediate server 360. Furthermore, data records may have any form of complexity required in order to provide the functionality required by the present invention.

Using the aforementioned techniques and apparatus, a service provider 32 can customize the capabilities of back-end software modules. This techniques and apparatus requires that the data stored by back-end software module to be referenced. One of skill in the art will appreciate that a number of back-end software modules provides methods in which the data stored by back-end software modules can be referenced and that such methods are highly application specific.

Another advantage that side-car management module 350 provides is the ability to host side-car data streams. This feature can be used to enhance the content that is provided by back-end software module 36. In one embodiment, side-car data management module 350 divides the display real estate by feeding a side-car data source into one part of the display while allowing the back-end software module to have another portion of the display. In instances where the data provided by back-end software module is referenced, side-car data management module can coordinate the side-car data source as a function of the referenced data that is provided by the back-end software module. For example, the back-end software module may be a program that stores content that includes uniform resource locator (URL) addresses. When a data record stored by back-end software module 36 is accessed by an end-user and the data record includes a URL, side-car management module 350 can be used to display the URL in separate panel of the display. In another embodiment, side-car data management module 350 can analyze the output of a back-end software module 36 in real time and use this analysis to assist in customized end-user directed advertisements or to optimize device 12 settings.

The side-car data sources that are used by side-car data management module 350 may be found in server 360 (FIG. 3, data sources 352). However, there is no requirement that the side-car data sources be resident in memory 318. In fact, such side-car data sources may be hosted in a back-end computer that is accessible to service provider 32.

### Exemplary Side-Car Data Source Processing Steps

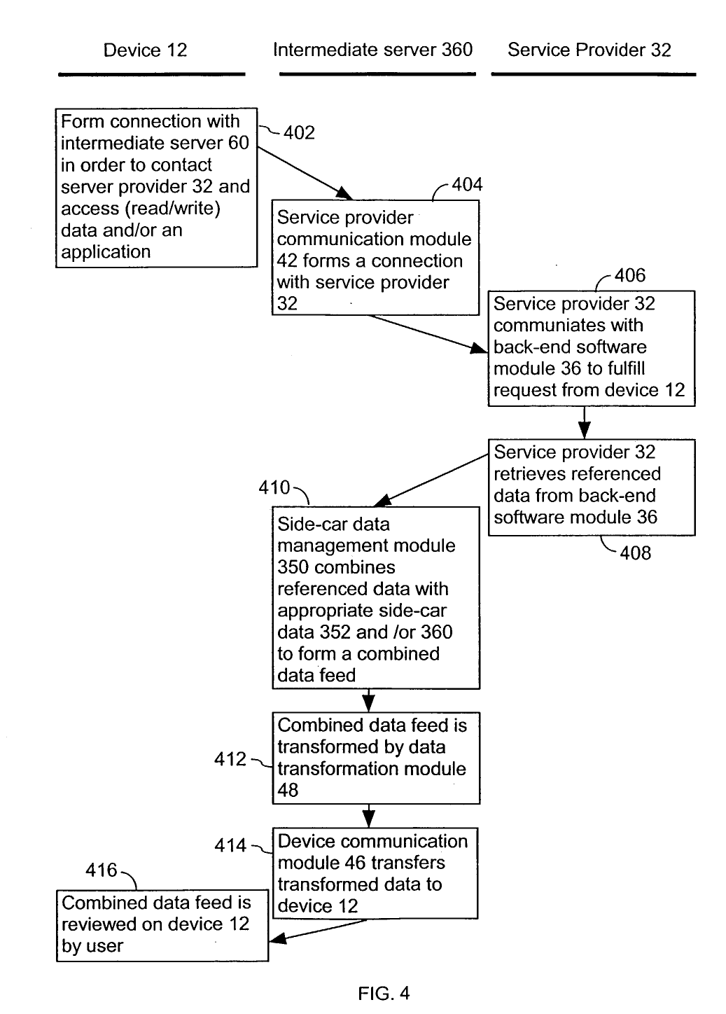

An exemplary system 302 that supports side-car data delivery has been disclosed. Processing steps that take advantage of the advantageous features of system 302 will now be described in conjunction with FIG. 4. In processing step 402, an end-user forms a connection with intermediate server 60 in order to contact service provider 32. This connection may be initiated by the user for any of several reasons, including reasons such as accessing E-mail, voice-mail, stock quotes, an address, or a bulletin board. In processing step 404, the service provider communication module 42 that is on intermediate server 360 responds to request 402 by forming a connection with service provider 32 (see FIG. 3). Then, in processing step 406, service provider 32 communicates with the back-end software module 36 that was requested by the end-user in processing step 402. Processing steps 402 through 406 occur in a manner that is transparent to the end-user. That is, the end-user uses a device 12 to communicate with one of the many back-end services that are offered by service provider 32. In one embodiment, the end-user is not aware that requests 402 are mediated by service provider communication module 42.

In processing step 408, service provider 32 retrieves requested data from backend software module 36. In many situations, request 402 is a request for specific data, such as an address entry stored by back-end software module 36. In such instances, the specific data is referred to as referenced data. Referenced data is any form of data that is stored by a back-end software module or that is accessible to a back-end software module in a determined and/or indexed manner. Examples of referenced data include address records stored by a back-end address program, financial records stored by a back-end financial program, and E-mail messages that are managed by a back-end E-mail program. Processing step 408 finishes by sending the requested data back to intermediate server 60.

In processing step 410, side-car data management module reviews the data sent by the service provider 32 to determine whether the data is referenced data. One definition of referenced data is any form of data received from an Internet service provider 32 for which there is associated data stored in a data record 50 in memory 318. When module 350 determines that the data is referenced, it combines the referenced data with the appropriate side-car data 352 and/or 360 in order to form a combined data feed. The format of the combined data feed is highly application dependent. To use the examples provided above, in one instance, the referenced data is an address record and side-car management module 350 has been configured to retrieve an image that is associated with the address record from a corresponding data record 50. In another instance, side-car data management module 350 determines that request 402 is a generalized web browsing request and, therefore, the web content retrieved in step 408 does not represent any form of data that is directly associated with a record 50. However, even in such instances, side-car data management module 350 can review the data to determine what forms of advertisements should be provided in the combined data feed.

Back-end data may referenced in any of a number of ways well known in the art. The method by which data is referenced in any particular application will depend on the type of back-end module 36 is used. For example, in some instances back-end module 36 is a Microsoft Exchange Server and the MAPI interface is used to detect changes in data stored by the Microsoft Exchange Server. The MAPI interface may be programmed, for example, using the Microsoft Application Design Environment toolkit. In another embodiment, backend module 36 is an SQL database such as an Oracle database. In such instances, a database trigger can be written and stored. The stored database trigger then watches for modifications to the data stored in the database.

At this stage, one of skill in the art will appreciate that side-car data management module 350 provide a service provider 32 with numerous advantages. Service providers 32 can enhanced back-end legacy products 36 by expanding the types of data such products can track and store. Furthermore, service providers can offer services, such as web access to users, who agree to accept a combined data feed at reduced costs.

Processing step 412 details additional features of the present invention. In step 412, the combined data feed is transformed by data transformation module 48 in conjunction with the device DNA 102 of the device used in processing step 402 to customize the data feed into a transformed data feed. Processing step 412 essentially optimizes the combined data for the specific device 12 that originated request 402. As an example, if the device DNA 102 of device 12 indicates that the device, in its current state, cannot accept sound or images, any sound or images in the combined data feed created in processing step 412 is stripped from the combined data feed during transformation 412. In this way, intermediate server 60 offers the additional advantage of optimizing the combined data feed for the specific device 12 that forms request 402.

In processing step 414, device communication module 46 (FIG. 3) transfers the transformed data to device 12. In some embodiments, device communication module 46 stores combined data feed 12 in a data record 50 in instances where the connection between the intermediate server 360 and device 12 has terminated. Then, at a later date, when the connection is restored between device 12 and intermediate server 360, device communication module 46 prompts the end-user to determine whether the user would like the combined data feed. In some embodiments, the combined data feed is deleted from intermediate server 360 memory if the connection to the device 12 is not restored within a predetermined time frame, such as one hour, one day, ten days, or three months.

In processing step 416, the combined data feed is reviewed on device 12 by the end-user. In some instance, only a portion of the combined data feed is reviewed by the end-user. Such instances may arise when the content that was added by side-care data management module 350 was, in fact, updated user settings for device 12.

### Intermediate Server Architecture

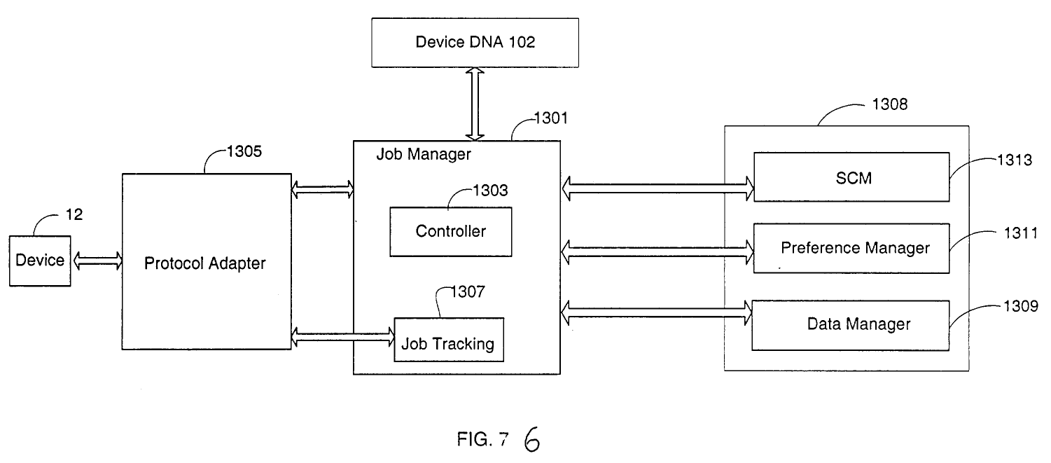

A preferred embodiment of the architecture of the intermediate server 60 is described with respect to FIG. 6. Stored on the intermediate server is a job manager 1301 that interfaces between the characterizations, such as device DNA records 102, other software application components 1308 and a protocol adapter 1305. The protocol adapter communicates with devices 12 via a protocol such as “syncML” or SOAP. It is to be understood that the apparatus of the present invention is not to be limited to the precise protocol used by the protocol adapter 1305. Indeed the protocol adapter may be capable of communicating with devices 12 via more than one protocol.

Software application components 1308 preferably comprise software applications for various management functions. In particular, software application components 1308 include, but are not limited to, software configuration management tools (SCM) 1313, at least one preference manager 1311 and at least one data manager 1309. Software configuration management tools 1313 handle the synchronization of software programs loaded on devices 12 with other devices 12 and with the service provider 32 (shown in FIG. 1). Preference management tools such as a preference manager 1311 control the synchronization of user preferences loaded on devices 12 with other devices 12 and with the service provider 32. Data management tools such as data manager 1309 manage the synchronization of user data loaded on devices 12 with other devices 12 and with the service provider 32.

The job manager 1301 preferably comprises one or more job management utilities that are dedicated to specific tasks. Such job management utilities are software modules internal to the job manager. For example, a job controller 1303 carries out functions such as job creation and deletion, and a job tracker 1307 handles job scheduling, tracking and rollback.

In particular, there are two principal scenarios where a job manager becomes important. In one circumstance, a service provider wishes to update a large number of similar devices in the same way and over a short period of time. For example, a cellular phone company wishes to make available to all holders of a particular model of cellphone a new ringing tone. In such a situation the job manager needs to be able to keep track of which devices have received the update as well as those that have not been reached and on which the update is yet to have been installed.

In another circumstance, a series of updates must be delivered to a single device over a period of time. In certain cases, these updates may be complex and time-consuming and must all be completed. Accordingly, a job manager finds utility in tracking those updates that have been successfully delivered and, if the device is disconnected before all the updates can be delivered, monitoring when the device is reconnected so that the remaining updates can be delivered.

### Surrogate Job Management Description

The intermediate server 60, often referred to as a “surrogate,” preferably characterizes an operation on characterizations, such as device DNA data, as a “job.” Such jobs are preferably controlled by a job management module, as described hereinabove. A job can be thought of as a logical transaction from a device's view and may contain one or more distinct operations, or tasks. Operations themselves are presented as discrete instructions or sets of instructions. Jobs may be initiated by a device or by the server.

One example of a job is: when the device downloads a service, the job is not completed until all the files are downloaded. For a SyncML device, a job is defined to be all of the messages in a package that need to be performed by the intermediate server. When a SyncML package contains several SyncML messages, the job is not finished for the device until the package is completed. Another example of a job is a server initiated task that will be executed by the server itself or a client device. For example, a change from an external server that needs to be propagated to the device the next time the device is connected. Operations within a job may be required to execute in a given order or may execute in random order, according to the overall nature of the job. In fact, for operations initiated by a device, the intermediate server may not be able to impose an order of execution.

From a device's viewpoint, the definition of a job is typically protocol dependent. Thus, the interpretation of a job is preferably the responsibility of the protocol adapter 1305.

The manner in which application components can formulate instructions for the job manager also depends upon the nature of the operation. There are principally two kinds of operation that can be defined in instructions to the job manager: an operation against an application component; and an operation that a device needs to complete.

Operations against application components can be formatted reasonably pragmatically. A typical operation can be described with the some or all of the following parameters: Job Id.; Security Token; User Id.; Device Id.; Name of target application component; Name of the command; and Parameters for the command. Other optional parameters may also be employed.

As a consequence of such an operation, a set of instructions may be created that needs to be executed within the context of the current job. These instructions may have to be executed immediately, or can be deferred until the end of the job. However, this functionality should not be abused by the application component to schedule a job for convenience. The idea of a job is that operations within a job are logically grouped together, so that if any operation has failed, the intermediate server can rollback other operations safely. By scheduling tasks that do not logically belong to the same job, harm may be caused to another job that could have otherwise executed successfully. The same principle applies to the job manager. While a device is connected, the job manager needs to examine pending jobs for the device in question and must try to execute the jobs within the context of other current jobs, for example one that has been initiated by the device itself. The pending jobs may fail or are preferably delayed. The Job manager should not permit pending jobs to adversely affect a current job or one another.

In the case of device operation, it is preferred to delegate all the responsibility to the device. Instructions delivered to the job manager will then simply comprise a directive that it should wait for the device to acknowledge the completion of some task.

### Jobs Initiated by a Device

In the case of job creation, it is preferred that a new job can only be created if there are no old jobs pending. It is further preferred that a new job is not created if it would be in conflict with any pending jobs.

Deciding whether two jobs conflict with each other can be difficult. For example, can a new user download a new service before the previous service download is finished? In such a circumstance, it is preferred that the SCM is responsible for deciding if there is a conflict for sure. However, since SCM only maintains a record of the currently perceived device state, it does not know the exact status of the immediately previous download. One simplified solution to this difficulty is that the “data type” can be partitioned into two kinds: data: one sort has no inter-relationship and the other sort does have an inter-relationship. Accordingly jobs which address databases that maintain data with an interrelationship must be serialized. For example, SCM data, most likely, contains interrelationships, so that a new job that alters SCM data preferably cannot be created until a previous job is completed.

Accordingly, before a job can be created, the job manager will call relevant application components to see if a new job can be created against them. Once an application component returns an affirmative response, the application must decide whether it needs to remember that a job has been created for it. For an application to decide whether two jobs conflict with each other, it can simply return an appropriate indication, in the affirmative or in the negative, depending on what type of data it supports and whether there is a pending job. Alternatively, the application can carry out some intelligent checking based on the nature of the two jobs.

In certain cases, a job can target a single component, i.e., type of data source such as an address book or an e-mail server, but it may require multiple components to accomplish this. This is further discussed hereinbelow. A separate matter is whether a job can target multiple components in the first place. The main problem with multiple components is that all of the components need to understand the “language” the client is using. Furthermore, simple cascading of multiple jobs to the same device by the job manager may not guarantee that the jobs are correctly handled.

On the other hand, job execution typically involves the interpretation of one or more protocol specific commands and dispatching those commands from the protocol adapter to the job manager then to the server component. Once a command is executed, the job manager needs to interpret the result and takes appropriate action to complete the request. In the example of a download service, when the SCM finishes execution of the download command, a list of actions is returned to the job manager. Using a specific example in which a user starts to subscribe to a particular e-mail service but for which the appropriate e-mail software is not installed on the user's device. In this case, actions may include (i) response sent back to the client, (ii) list of files to be downloaded by the device before the job is completed for the client, (iii) a notification that the job has been completed, (iv) list of actions to be taken by the server once the device has completed the download, (v) notification to the preference manager so that updated preferences can be sent out to different devices used by the user, and (vi) callback to SCM for post processing, followed by termination of the job. The last of these, callback to the SCM, comprises for example, miscellaneous tasks that the SCM may need to carry out to clean up the job. The notification to the preference manager may, alternatively, occur as part of a separate job, or after the post-processing operations have been carried out.

Furthermore, job tracking preferably is handled by the job manager. Job tracking involves maintaining enough information to resume a previously interrupted job or to rollback a terminated job. The protocol adapter, job manager, and server components, all preferably utilize some level of job tracking. For the protocol adapter, it is desirable to keep track of the status of device commands so that it can perform protocol specific recovery when a job is interrupted. The Job manager preferably keeps track of all the actions it has performed on the server component, or the most recent actions, up to a predefined number. Server components preferably remember what action they have performed for each command from the job manager. Ideally, it is preferable to have a single infrastructure for job tracking.

There are many possible ways to terminate a job. A job can complete naturally, thereby terminating itself. Or, a job maybe canceled by the device before it is completed. Usually, the server can't cancel a job without the device's consent. A job can also be interrupted by a communication problem. In such a situation, the next time the device connects, the server is preferably able to support two capabilities. First, if the device intends to resume the job, the server needs to be able to resume the job from the last, i.e., most recent interruption. Determining the point from which to resume is usually the sole responsibility of the protocol adapter. Second, if the device starts a new job, the server is preferably able to determine the state of the device and take proper actions to re-synchronize the device state with server's stored perceived device state. To achieve such a re-synchronization, usually requires some cooperation between the job manager and the server components to properly rollback the actions performed for this job.

Whether a server can unilaterally cancel a job is usually a protocol dependent issue. Assuming that the server can cancel a job if the job is inactive for an extended period of time, the job manager should preferably be able to guarantee that, the next time the device connects, the protocol adapter can tell unambiguously that this job has been canceled and thus that the device can be informed of the cancellation in a proper manner.

By contrast, rolling back a previously executed command is preferably the responsibility of the job manager and the application components called by the job manager. Since rollback usually means to undo a previously completed operation, the job manager preferably supplies enough information to the application components to carry this out. It is possible that the job manager will not be able to supply enough information for a specific command executed by a specific application component. In such circumstances, the application component preferably keeps track of enough information so that it could rollback the previous operations.

### Jobs Initiated by the Server

There are certain operations that resemble a job but which are not handled by the job manager. For example, a service provider has changed the definition of a service and subscribing users need to be upgraded accordingly. Or, a service provider has changed the definition of a package and subscribing users need to be notified. Another example is whereby a change from an external server needs to be propagated to all the relevant devices owned by a particular user.

If these tasks are considered to be viable jobs, there are two straightforward ways these types of problems can be solved. Either SCM can schedule a job for each device or SCM can schedule a single job for all devices. Both approaches have drawbacks, however. The first approach requires creating a huge number of jobs in a short period of time which can lead to a lot of system clutter. The second approach means, most likely, that the job will never be totally removed from the system, i.e., completed because one or two stray devices may never have been reached. Any variation of these types of solutions will most likely also be unsatisfactory in the sense that it would either consume too much resource or it would be very difficult to decide whether and when a job is truly finished. As a consequence, such tasks should be treated on a case by case basis. A sub-category of these type of jobs includes jobs that have unspecified numbers of targets but which have expiration dates. A good example is a news feed. The Job manager can generically manage jobs with a description like “send this news to every user who subscribes to this news category until 8:00 pm today.” This sort of scenario does not apply to the SCM case described hereinabove, in which it is implied that SCM needs to solve the problem within its own application.

Accordingly, it is preferable to impose on the server a limitation that the number of jobs created by any task must not exceed or have the potential of exceeding a pre-defined limit. Consistent with such a constraint, a job preferably has a well-defined number of targets or must have an expiration time.

In general, server initiated jobs have several characteristics that are different from device initiated jobs, as follows:

The job is created by some application server component;

Job creation will always be successful.

The job may not be executed until the next time the device is connected.

The job may be executed within the context of a job initiated by the device.

T illustrate these points, when a data manager (DM) receives a change from the external server, the DM will call the job manager to create a job. The creation of the job will always be successful since the DM need not consult any other component to decide whether this job can be created. When the device connects, the job manager will call the DM to see if it can complete this job at this time. The DM will execute this job and formulate the proper response to job manager. The job manager will incorporate this response with the responses from other components and send them back to the device.

It is important to note that, other than the creation of the job, for the case of a server initiated job, the execution, status tracking, termination, and rollback are still performed the same way as in the case of a job that is initiated by a device.

### Exemplary Electronic Devices

Referring to FIG. 5, an electronic device 12 typically includes the following components: a network interface 601, a processor 602, a user interface 606, a memory 608, and a bus 610, which interconnects the aforementioned components. The network interface 601 couples the electronic device 12 to intermediate server 60 (FIG. 1). The precise structure of this component is governed by how the electronic device communicates with the intermediate server 60 (e.g., wireless or wireline). Processor 602 executes various software modules maintained in memory 608 as described in more detail below. User interface 606 enables a user to interact with the electronic device 12 and typically includes components such as a keyboard, touch pad screen/display, microphone, and speakers.

Memory 608, which typically includes high speed random access memory as well as non-volatile storage such as disk storage, stores an operating system 612, a client module 614, one or more software modules 616, device settings 626, device preferences 628, and shared-memory 630 managed by the operating system 612.

Operating system 612 includes procedures for handling various basic system services and for performing hardware dependent tasks. Operating system 612 also provides software modules 614 and 616 with access to system resources, such as the memory 608 and user interface 606.

Client module 614 enables the intermediate server 60 to manage the electronic device 12. More specifically, client module 614 can receive and process data from intermediate server 60. For example, intermediate server 60 may transmit a software module and an instruction to install the software module to the electronic device 12. Client module 614, in communication with the intermediate server 60, receives the software module and initiates the installation of the software module. Client module 614 also has access to the shared-memory 630, device preferences 628, device settings, and software modules 616, including the settings 617, preferences 618, and data 619 of the software modules 616. Accordingly, client module 614 is capable of modifying, adding, or deleting all or some aspect of each. Client module 614 may also transmit some or all of the device preferences 628, device settings 616, and software modules 616, including the settings 617, preferences 618, and data 619 of the software modules 616 to the intermediate server 60 and/or a service provider 32.

Client module 614 preferably communicates with intermediate server 60 using an efficient protocol. In particular, the protocol preferably operates effectively over both wireless and wired networks, is adaptable to the capabilities of each type of electronic device 12 described herein, and supports a wide variety of transport protocols. In some embodiments of the present invention, client module 614 comprises a SyncML stack (see, for example, http://www.syncml.org).

Software modules 616 include all manner of applications found in electronic devices 12. An exemplary software module 12 is an E-mail program. E-mail programs in general include settings 617, preferences 618, and data 619. Settings 617 and preferences 618 are similar concepts and include, for example, limitations on the size of a corresponding address book and interface preferences. As indicated above, data 619 may comprise an address book or other information.

Device settings 626 may control how the electronic device 12 interacts with intermediate server 60. Each of the software modules 616, therefore, access intermediate server 60 in a manner defined by the device settings 626. Similarly, the device preferences 628 may preselect certain options when such options are presented to the electronic device 12. For example, when a software module 616 is being installed, it may default to a particular language as defined by the device preferences 628. And the shared-memory may be used by the software modules 616, operating system 612, and/or the client module 614 to store information independently or under the direction of a user.

Persons skilled in the art recognize that the precise make up of the electronic device 12 depends upon its nature. For example, some electronic devices 12 are more complex than others. The more complex a electronic device is, the more likely it is that the electronic device 12 includes components not found in more simplistic electronic devices 12. Generally, many embodiments of the present invention may use any electronic device 12 with capability to communicate with the intermediate server 60, with elements manageable by the intermediate server 60, and with capability to manage the manageable elements (e.g., client module 614). The range of electronic devices 12 includes but is not limited to handheld computers, laptops, routers, switches, appliances, wearable computers, personal digital assistants, cellular telephones, pager, electronic note-pad or a palm-top computers, e-books, smart-cards, cameras, dicta phones, heart-rate monitors, cycle computers, pedometers, wristwatch computers, GPS devices, electronic toys, games, car navigation systems, home gateway appliances (see, for example http://java.sun.com/products/consumer-embedded/homegateway or http://www.osgi.org/), or other amusement devices, and home security controllers.

A switch is a layer 2 network device that selects a path or circuit for sending a unit of data to its next destination, where layer 2 refers to a the second layer in the International Organization for Standardization Reference Model of Open System Interconnection (ISO OSI Model). It will be appreciated, however, that a switch may also include the function of a router, which is a layer 3 device or program that can determine the route and specifically what adjacent network point the data should be sent. For more information on switches and routers, see Peterson and Davie, Computer Networks, 1996, Morgan Kaufmann Publishers, Inc, San Francisco Calif. For this reason, in some embodiments of the present invention, an electronic device 12 is a router or switch.

### Exemplary Device DNA Database

Referring to FIG. 1 for exemplary network topology, one embodiment of the present invention includes a device definitions database in memory 18 (not shown). Device definitions database describes electronic devices 12 in detail. More specifically, the device definitions database comprises a device record for each of the electronic devices 12 in system 10. The device records preferably include fixed hardware descriptions, removable hardware descriptions, and operating system descriptions of the electronic devices 12. The device records also preferably include information such as typical device configurations, supported software modules, feature sets, and hardware limitations. For example, if a particular version of an electronic device 12 (e.g., a hand held computer) only has a monochrome display, this fact is included in a corresponding device record. As described in more detail below, each device record includes information that enables the creation of device DNA 102 for a corresponding electronic device 12. The device definitions database is preferably updated as new electronic devices 12 become available.

One embodiment of the present invention includes a software modules database in memory 18 (not shown). The software modules database comprises software modules. More specifically, the software modules database includes a software module record for each software module that may be required by the electronic devices 12 described in the device definitions database. In other words, the software modules database includes all software modules required by the services offered by a service provider 32 (FIG. 1). The software modules database preferably includes software modules such as e-mail programs, games, dynamic link libraries, and virtual machines and software modules such as patches and/or upgrades that modify the first type of software modules. The software modules database is preferably updated as new software modules become available.

One embodiment of the present invention includes a software definitions database in memory 18 (not shown). The software definitions database comprises a plurality of software definition records that include descriptions of the software modules stored in the software modules database. Each software definition record preferably describes software module (i.e., other software modules required for execution) and hardware requirements of a corresponding software module. For example, if a given software module requires one or more other software modules for execution, a list of these software modules is included in the software definition record. Additionally, memory usage and processor speed requirements, for example, may also be included in the software definition record. The software definitions database is preferably updated as new software modules are added to, deleted from, or modified in the software modules database.

In alternate embodiments, the software modules database and the software definitions database are combined. In these embodiments, each record of the database includes a software module and corresponding description.

The device DNA database 52 (FIG. 1) includes a device DNA 102 for each electronic device 12 that interacts with the intermediate server 60. More specifically, the device DNA database 52 includes one or more record 102 for each account 54 created by the service provider 32 and forwarded to the intermediate server 60. Each of these records 54 includes a sub-record 102 (device DNA) for each electronic device 12 corresponding to the account. Included in a sub-record is detailed information about the corresponding electronic device 12. For example, device DNA 102 for a given electronic device 12 includes information such as a fixed hardware description, a removable hardware description (including whether a given removable hardware component was ever attached), a list of software modules included on the electronic device 12, software module settings and preferences, a description of the data for each of the software modules (but preferably not the data itself), data source settings, a list of users who can use the electronic device 12, the device specific configuration for each service on the device (e.g., the location of the mail server), and device specific mappings of data sources (e.g., which address book entries are stored on which device for a specific user). Descriptions of the data typically identify when the data was last changed, periods in which the data did not change, how many entries are included (in the case of a list or database), the size of the data, and/or a general description of the data.

In one embodiment of the present invention, device DNA 102 is uploaded to intermediate server 60 from an electronic device 12 in order to update a corresponding device DNA entry 102. Additionally, the device DNA 102 may be updated by the service provider 32 (e.g., when a user, through the service provider 32, adds or removes a service supplied by one or more electronic devices 12 corresponding to the user's account). The device DNA 102 of a given account 54 may also be changed in a manner that corresponds to changes made to another device DNA 102 within the same account 54.

A service provider 32 typically provides a defined number of services. Additionally, an electronic device 12 may include software modules and data unrelated to the services provided by a service provider 32. In preferred embodiments of the present invention, information pertaining to such software modules and data is not included in the device DNA. Instead, such information is preferably excluded entirely from the device DNA or included only to the extent that it affects software modules, data, etc., corresponding to a service provided by a service provider 32. For example, if the software definitions database indicates that a first software module (i.e., a software module not included in the software module database) conflicts with a second software module (i.e., a software module included in the software module database), the device DNA 102 may reflect that the first software module is installed on a corresponding electronic device 12.

### Alternate Embodiments

The present invention can be implemented as a computer program product that includes a computer program mechanism embedded in a computer readable storage medium. For instance, the computer program product could contain the program modules and data structures shown in FIGS. 1 and 3. These program modules and data structures may be stored on a CD-ROM, magnetic disk storage product, or any other computer readable data or program storage product. The software modules in the computer program product may also be distributed electronically, via the Internet or otherwise, by transmission of a computer data signal (in which the software modules are embedded) on a carrier wave.

While Device DNA 102 has been described relatively simplistically in some instances as a “record” those of skill in the art will appreciate that data structure of device DNA can be quite complex because of the large number of conditions, variables and states that are tracked by this data structure.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

What is claimed is:

1. A method for standardizing data on a plurality of electronic devices, wherein a service provider offers one or more back-end software modules to at least one of said plurality of electronic devices, and wherein one of said back-end software modules has data associated with it, the method comprising:
storing a plurality of characterizations, wherein said plurality of characterizations includes a separate characterization for each of said electronic devices;
detecting a change in said data associated with one of said back-end software modules;
receiving, in response to an interaction from one of said plurality of electronic devices, said change in said data associated with one of said back-end software modules; and
creating an updated characterization for said one of said plurality of electronic devices.

2. The method of claim 1, wherein the separate characterization includes a description of a software module in the corresponding electronic device.

3. The method of claim 1, wherein the separate characterization includes a description of a hardware component included in the corresponding electronic device.

4. The method of claim 1, wherein the separate characterization includes a description of an electronic device setting in the corresponding electronic device.

5. The method of claim 1, wherein the separate characterization includes a characterization of user-defined preferences of the corresponding electronic device.

6. The method of claim 1, wherein the separate characterization comprises control information for data maintained on the corresponding electronic device.

7. The method of claim 1, wherein the separate characterization includes a description of data maintained on the corresponding electronic device.

8. The method of claim 1, wherein the separate characterization includes configuration information for a service provided to the corresponding electronic device.

9. The method of claim 1, wherein the separate characterization includes configuration information for a service provided by the corresponding electronic device.

10. The method of claim 1, wherein the separate characterization includes configuration information for a service provided to the corresponding electronic device.

11. The method of claim 1, wherein an electronic device in said plurality of electronic devices is a pager.

12. The method of claim 1, wherein an electronic device in said plurality of electronic devices is a car navigation system.

13. The method of claim 1, wherein an electronic device in said plurality of electronic devices is a router or a switch.

14. The method of claim 1, wherein an electronic device in said plurality of electronic devices is a handheld computing device.

15. The method of claim 1, wherein an electronic device in said plurality of electronic devices is a wireless telephone.

16. The method of claim 1, wherein an electronic device in said plurality of electronic devices is a home gateway appliance.

17. A method for delivering data to an end-user in a networked environment, the method comprising:
receiving data in a centralized location requested from said end-user;
transforming said data to form transformed data in accordance with a plurality of characterizations, wherein said plurality of characterizations includes a separate characterization for each of a plurality of electronic devices associated with said end-user; and
storing in said centralized location, for each electronic device in said plurality of electronic devices, the data that has been transformed in accordance with the characterization of the electronic device.

18. The method of claim 17 wherein the receiving step further comprises:
detecting a change in data associated with a back-end software module;
communicating with said back-end software module to query said change in said data; and
obtaining the data that has been changed from said back-end software module.

19. The method of claim 17, the method further comprising;
opening a connection between said centralized location and one of said plurality of electronic devices associated with said end-user; and
transferring the data that has been transformed and stored in accordance with the characterization of the electronic device.

20. The method of claim 17, the method further comprising processing said transformed data on said one of said plurality of electronic devices.

21. The method of claim 20, wherein said processing comprises review of said transformed data.

22. The method of claim 17, wherein an electronic device in said plurality of electronic devices is a pager.

23. The method of claim 17, wherein an electronic device in said plurality of electronic devices is a car navigation system.

24. The method of claim 17, wherein an electronic device in said plurality of electronic devices is a router or a switch.

25. The method of claim 17, wherein an electronic device in said plurality of electronic devices is a handheld computing device.

26. The method of claim 17, wherein an electronic device in said plurality of electronic devices is a wireless telephone.

27. The method of claim 17, wherein an electronic device in said plurality of electronic devices is a home gateway appliance.

28. A method for providing data in a networked environment, the method comprising:
retrieving referenced data from a back-end software module;
combining said referenced data with data from an auxiliary data source in order to form a combined data feed; and
transforming said combined data feed in accordance with a characterization of a device; wherein said characterization of said device is from a plurality of characterizations, and wherein said plurality of characterizations includes a separate characterization for each of a plurality of electronic devices.

29. The method of claim 28, the method further comprising communicating said combined data feed to said device.

30. The method of claim 28, wherein said retrieving further comprises communicating a request for referenced data from said back-end software module.

31. The method of claim 28, wherein said auxiliary data source is relational database, a lightweight directory access protocol (LDAP) data store, or a file store.

32. The method of claim 28, wherein said auxiliary data source is a stored image.

33. The method of claim 28, wherein said back-end software module is an LDAP data store, an Internet Message Access Protocol mail store, a Microsoft Exchange server, or a relational database containing service provider data.

34. The method of claim 28, wherein an electronic device in said plurality of electronic devices is a pager.

35. The method of claim 28, wherein an electronic device in said plurality of electronic devices is a car navigation system.

36. The method of claim 28, wherein an electronic device in said plurality of electronic devices is a router or a switch.

37. The method of claim 28, wherein an electronic device in said plurality of electronic devices is a handheld computing device.

38. The method of claim 28, wherein an electronic device in said plurality of electronic devices is a wireless telephone.

39. The method of claim 28, wherein an electronic device in said plurality of electronic devices is a home gateway appliance.

40. An apparatus for providing data in a networked environment, the apparatus comprising:
a plurality of electronic devices for originating a request;
an intermediate server that is intermittently connected to at least one device in said plurality of devices, the intermediate server including a plurality of characterizations, said plurality of characterizations including a separate characterization for each of said plurality of electronic devices; said intermediate server including:
a service provider communication module for forwarding said request to a back-end software module and for receiving data from said back-end software module in accordance with said request;
an auxiliary data management module for combining said data with an auxiliary data source in order to form a combined data feed;
a data transformation module for transforming said combined data feed into a transformed data feed in accordance with a characterization selected from said plurality of characterizations.

41. The apparatus of claim 40, the intermediate server further comprising a device communication module for receiving said request and for communicating said transformed data feed to the device that corresponds with said characterization selected from said plurality of characterizations.

42. The apparatus of claim 40, wherein said back-end software module is hosted by a back-end server that is in communication with said intermediate server.

43. The apparatus of claim 40, wherein said back-end software module is a stock tracking program, an address program, an E-mail program, or an accounting program.

44. The apparatus of claim 40, wherein an electronic device in said plurality of electronic devices is a pager.

45. The apparatus of claim 40, wherein an electronic device in said plurality of electronic devices is a car navigation system.

46. The apparatus of claim 40, wherein an electronic device in said plurality of electronic devices is a router or a switch.

47. The apparatus of claim 40, wherein an electronic device in said plurality of electronic devices is a handheld computing device.

48. The apparatus of claim 40, wherein an electronic device in said plurality of electronic devices is a wireless telephone.

49. The apparatus of claim 40, wherein an electronic device in said plurality of electronic devices is a home gateway appliance.
